(19) United States
(12) Patent Application Publication
(10) Pub. No.: US 2011/0278038 A1
(43) Pub. Date: Nov. 17, 2011

(54) COMBINED CABLE TROUGH AND WALKWAY

(75) Inventor: Stewart Wellens, Greater Manchester (GB)

(73) Assignee: TROJAN SERVICES LIMITED, Greater Manchester (GB)

(21) Appl. No.: 13/146,746

(22) PCT Filed: Jan. 28, 2010
(86) PCT No.: PCT/GB2010/050134

§ 371 Date: Jul. 28, 2011

(30) Foreign Application Priority Data
Jan. 30, 2009 (GB) 0901544.7

(51) Int. Cl. H02G 9/04

(52) U.S. Cl. 174/39

(57) ABSTRACT

Disclosed is a combined cable trough and walkway comprising: a first component for carrying cables, said first component having a channel formed from a base and two generally upright sidewalls extending therefrom, wherein said channel is divided into two sub-channels by a generally upright member extending from the base; and a second component, arranged in use, to form a lid to cover the first component and to provide a walkway, and wherein the first component comprises a plurality of parts arranged to be fitted together before use.

The present invention concerns a combined cable trough and walkway for use primarily in a railway environment for routing and carrying communication and/or power cables and which also has a function as a safe level walkway beside a railway track.

Railway tracks are frequently laid on uneven ground which has been topped off with ballast, which is essentially rubble. When railway technicians and engineers are required to work on the railway, they often have to walk significant distances alongside the railway track over this ground. The unevenness of this ground poses a problem for the workers and makes it difficult to transport tools and equipment if there is no corresponding access roadway.

In the UK, Network Rail, the owners and operators of the rail infrastructure, have in place regulations that dictate certain requirements for provision of a safe and level walkway alongside railway tracks. Currently, such walkways tend to consist of flattened and compressed earth and are not generally suitable to transport tools and equipment.

At the same time, there is a requirement to provide routing for cables alongside railway tracks. These cables can be used for transmitting power around the railway network, or for signalling and communication purposes. Sometimes, third parties lease space in the routing system and make use of the extensive railway network to route their own communication cables around the country.

Accordingly, there is a need to provide a system for implementing walkways to run alongside railway tracks in a quick, easy and economic manner, which can be easily retrofitted to existing railway infrastructure.

Embodiments of the present invention aim to address problems in the prior art, and other problems whether mentioned explicitly herein or not.

According to the present invention there is provided an apparatus as set forth in the appended claims. Other features of the invention will be apparent from the dependent claims, and the description which follows.

For a better understanding of the invention, and to show how embodiments of the same may be carried into effect, reference will now be made, by way of example, to the accompanying diagrammatic drawings in which:

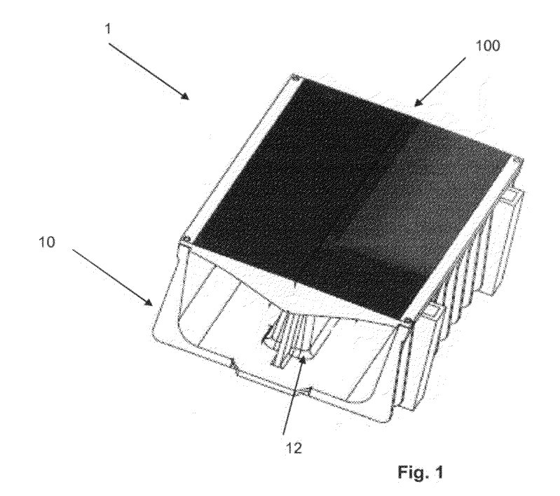

FIG. 1 shows a perspective view of an embodiment of the invention;

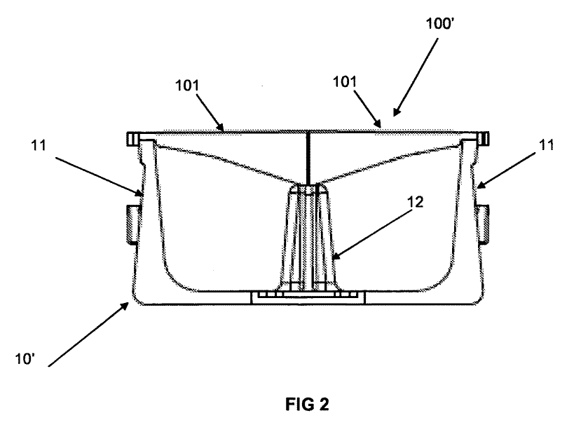

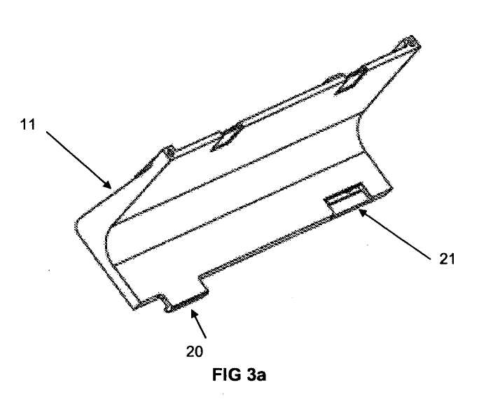

FIG. 2 shows an end view of an embodiment of the invention;

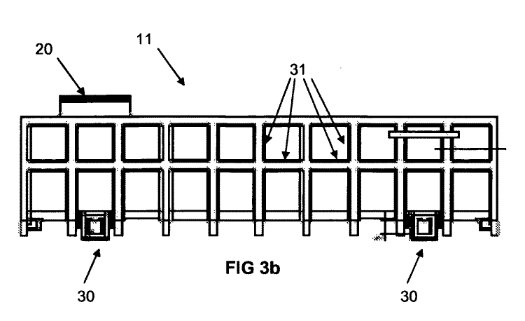

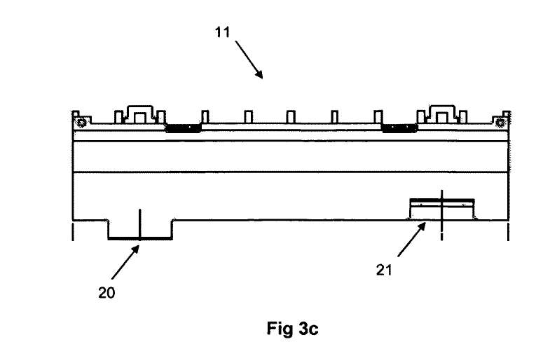

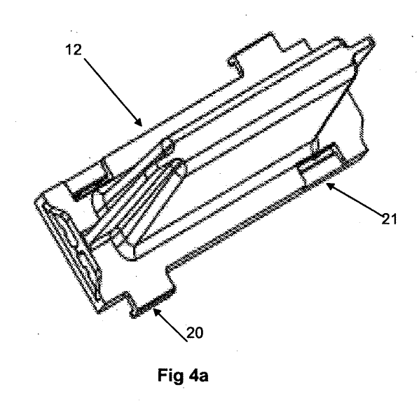

FIG. 3a-c show perspective, bottom and top views, respectively, of a side wall component forming part of an embodiment of the present invention;

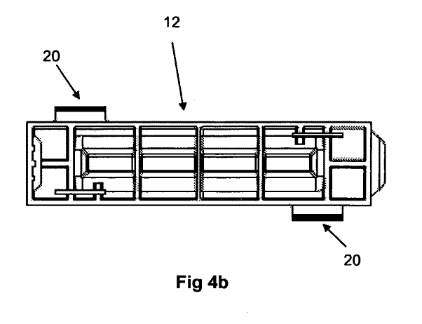

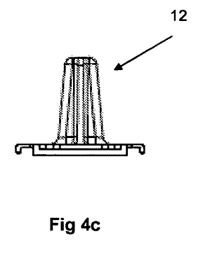

FIG. 4a-c show perspective, bottom and end views, respectively, of an upright member forming part of an embodiment of the present invention; and

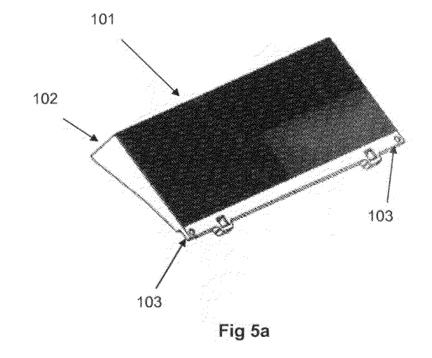

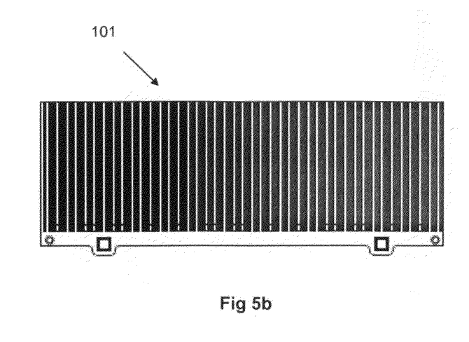

FIGS. 5a and 5b show perspective and top views, respectively, of a lid component forming part of an embodiment of the present invention.

FIG. 1 shows a perspective view of an assembly 1, comprising a trough 10 together with lid 100. The trough is arranged in use to be wholly or partially buried alongside a railway track. The trough is generally U-shaped and a plurality of such troughs are arranged end to end to carry cables associated with the railway system. These may be power cables, signalling cables, data communication cables or cables carried for third parties, such as fibre-optic data cables.

The cable trough component 10 is constructed from a plastics material. The plastics material comprises a polymer which is preferably recycled. In a preferred embodiment the preferred polymer is a polyolefin. The trough component 10 is preferably constructed using an injection moulding process.

The generally U-shaped channel formed by the trough is separated into a pair of sub channels by a central upright member 12, which extends from the base of the trough. The upright member 12 has two major functions. The first function is to divide the trough into two sections, which can assist with cable segregation and management (for instance, physically separating high voltage cables from data cables). The second function is to assist in supporting the lid/walkway, when it is in place.

The dimensions of the trough component may be selected as needed, but there is a standard applicable in at least the UK which dictates that a walkway provided at the side of a railway line must be at least 700 mm wide. Preferred embodiments of the present invention meet this requirement.

In a first embodiment of the invention, the trough 10 is formed as a single piece by injection moulding. Likewise, the lid 100 is formed as single piece. However, it is found, in practice, that the mould size required to make such a trough, can be excessive and can, in some cases, result in manufacturing problems in some instances.

Therefore, in a second embodiment of the invention, the trough 10′ is manufactured as three separate components which are assembled to provide a component which is functionally identical to the single piece component 10 of the first embodiment. Similarly, the lid/walkway 100′ is manufactured as two separate components which are assembled into a lid/walkway which is functionally identical with the lid/walkway 100 of the first embodiment.

One advantage of forming the trough 10′ from separate components is that the moulds required to make the components are smaller, more manageable and result in smaller parts which can be more easily packaged and transported. In addition, by careful design of the components, the number of different individual components can be minimised.

In FIG. 2, it can be seen how the trough 10′ is constructed from three separate components 11, 11 and 12, but note that the components 11 are identical. Each of the connectors which allow the components to inter-connect are arranged to have a male and female fitting for interconnection to a complementarily-gendered connector. The trough 10′ shown in FIG. 2 is functionally identical with the unitary trough 10 shown in FIG. 1.

FIGS. 3a-3c show various views of the side wall component 11. FIGS. 4a-4c show various views of upright member 12.

Side wall component 11 has a male connector 20 towards its bottom, as viewed in FIG. 3a and a female connector 21 towards its top. The upright portion 12, as shown in FIG. 4a, has a male connector 20 adjacent the female connector 21 of the side wall member 11 and vice-versa. Finally, to complete the trough 10′, the other side wall component 11 is identical with the first side wall component 11, but rotated through 180°, such that its male connector 20 is adjacent the female connector 21 of the upright member 12 and vice-versa.

In this way, only one type of side wall component 11 is required, regardless of whether it is to be configured as a left or a right hand side wall. This form of connection arrangement has a further advantage in that, for troughs which are required to be narrower, the side wall components 11 can be directly connected together, and a narrower lid can be fitted. In this case, there is no upright portion 12, and the narrower lid is able to adequately span the reduced width of this arrangement without requiring additional support.

In the same way that the trough 10′ can be constructed from a number of discrete smaller components, the lid 100′ can be constructed from two identical, smaller, components 101. This is shown in FIG. 5a. As with the side wall components, the components 101 which make up the lid/walkway 100′ are identical and can be fitted either way round, requiring a minimal number of components to be manufactured and/or held in stock.

By manufacturing the individual components in this way, they can be much more easily manufactured, stored and transported before being assembled on-site.

To assemble the trough 10′ from components 11 and 12, it is a simple matter of aligning the respective male 20 and female 21 connectors and pressing hard to snap the parts together. Once connected in this way, it is very difficult, but no impossible, to separate them. Various ways of ensuring a suitable permanent or semi-permanent (meaning that the parts will not ordinarily come apart in use but may be separated, perhaps by use of a special tool) connection are possible. For instance, a frictional fit can be employed whereby a slight taper is introduced to either the male or female part so that a tight fit is achieved between male and female parts respectively. Alternatively, some form of external fastening, such as a screw, nut and/or bolt, rivet or similar device may be used.

Turning to features of the components 11 and 12 which form the trough, it can be seen in FIG. 3b that the side wall component is provided on its outer upright surface with a pair of apertures 30. These are provided so that a safety handrail can be added to the walkway if required. The safety handrail is not shown, but takes the form of a pair of vertical members spaced to fit in the pair of apertures and joined by a substantially horizontal member. Such a safety barrier may be used in certain track-working situations to shield workers from passing trains.

The side wall component 11 has a relatively smooth interior surface, to prevent or minimise cable-chafing. The exterior surface is provided with a range of horizontal and vertical ribs 31 for providing strength and added rigidity to the component. The recesses formed between the ribs helps keep the trough in position once the trench in which it is usually situated is backfilled with material.

The upright member 12 is dimensioned so that its height, once assembled into the trough 10′ is slightly lower than the height of the two side walls. This is because the lid/walkway component 101 is provided with a range of buttress-like support ribs 102 which extend from a relatively thin end at the outer edge of the lid/walkway 100′, to a relatively thick end at the centre of the lid/walkway. The reduced height of the upright member 12 is to compensate for the extra thickness of the lid/walkway at its central position. This ensures that the lid/walkway is substantially flat in use.

The lid/walkway 100′ is provided with a textured upper exposed surface, so that an improved grip is provided for track workers who may have to walk on it in wet or icy conditions. The textured surface can take the form of parallel grooves or ridges, or any other suitable pattern.

The lid/walkway 100′ is provided with means for securing it firmly in position once attached to the trough 10′. The means provided take the form of apertures positioned to align with corresponding apertures provided in the trough 10′. Fastening devices, such as screws or nuts, can then be used to close the trough 10′ with the lid/walkway 100′. Preferably, anti-tamper fasteners are used so that a special tool is requires to remove them.

The lid/walkway 100′ may, in some embodiments, be provided with reflective devices which serve to render the surface of the walkway more visible in reduced lighting conditions. Often, track maintenance is performed overnight, to minimise disruption to rail timetables. As such, the trackworkers often work using head-mounted torches. By providing reflective elements, preferably along the edges of the walkway, it is easier for them to discern the limits of the walkway and so remain safely away from the railway track. The reflective elements can be positioned in the mould so that they become incorporated during the moulding process.

The lid/walkway 100′ can be provided with a slightly bowed surface to facilitate the draining of any rainwater which may otherwise collect on the surface. Similarly, an incline can be formed in one or both of the sub-channels so that water tends to run towards an end of the trough where it may escape to earth at the junction between adjoining troughs.

The base of the trough 10′ can optionally be provided with one or more cable cleats to securely fasten the cables therein in position. This can assist in cable segregation and also in cable security. There is a growing problem of thieves stealing copper cabling from trackside installations. If the individual cables are fastened in place in each trough 10′, then it becomes much more difficult to remove the cables.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A combined cable trough and walkway comprising:
a first component for carrying cables, said first component having a channel formed from a base and two generally upright sidewalls extending therefrom, wherein said channel is divided into two sub-channels by a generally upright member extending from the base; and
a second component, arranged in use, to form a lid to cover the first component and to provide a walkway, wherein the first component comprises a plurality of parts arranged to be fitted together before use.

2. The combined trough and walkway of claim 1 wherein the first component comprises first and second side wall members and an upright member positioned therebetween in use.

3. The combined trough and walkway of claim 2 wherein the first and second sidewall members are identical.

4. The combined trough and walkway of claim 1 wherein the plurality of parts are provided with complementary male and female connectors to allow respective parts to be inter-connected.

5. The combined trough and walkway of claim 1 wherein a base of the sub-channels is sloped to allow water to drain towards and end of the first component.

6. The combined trough and walkway of claim 1 wherein the first component is provided with male and female connectors to mate with respective complementary connectors on other said first components.

7. The combined trough and walkway of claim 1 wherein the second component comprises a plurality of angled support members, extending from a relatively thin portion towards an external edge of the second component to a relatively thick portion towards a centre of the second component, whereby the relatively thick portion sits, in use, on the generally upright member.

8. The combined trough and walkway of claim 1 wherein the second component is provided with fastening means to securely attach it, in use, to the first component.

9. The combined trough and walkway of claim 1 wherein the second component is provided with reflective means to render the walkway more visible under torchlit conditions.
